(19) United States
(12) Patent Application Publication
(10) Pub. No.: US 2020/0234338 A1
(43) Pub. Date: Jul. 23, 2020

(54) CONTENT SELECTION APPARATUS, CONTENT SELECTION METHOD, CONTENT SELECTION SYSTEM, AND PROGRAM

(71) Applicant: NEC Corporation, Tokyo (JP)

(72) Inventor: Hiroyuki TOMIMORI, Tokyo (JP)

(73) Assignee: NEC Corporation, Tokyo (JP)

(21) Appl. No.: 16/736,243

(22) Filed: Jan. 7, 2020

(30) Foreign Application Priority Data
Jan. 17, 2019 (JP) 2019-005919

(51) Int. Cl. G06Q 30/02; G06K 9/00

(52) U.S. Cl. CPC G06Q 30/0269; G06Q 30/0261; G06K 2009/00322; G06K 9/00362; G06K 9/00281

(57) ABSTRACT

[Problem] A main object is to provide a content selection apparatus, a content selection method, a program, and the like that select a content with a high advertising effect.

[Solution]Included are an extraction means for extracting, from image data, information about a feature of a person included in the image data, a determination means for determining, based on the extracted information, whether a person included in the image data is a non-target, which is a person who is not a target to which a content is presented, and a selection means for selecting a content, based on information about a person determined not to be a non-target by the determination means from among the extracted information.

### TECHNICAL FIELD

The present disclosure relates to an apparatus, a method, a system, and a program for selecting a content.

### BACKGROUND ART

In stores, public facilities, and the like, a system called digital signage that presents information by using electronic devices is used.

In general, a digital signage switches an output content on the basis of statically determined rules. In recent years, a method has been known in which an image for a certain range is captured by using an imaging apparatus and the content is switched on the basis of information about a person located in the certain range in order to improve an appeal effect being an advertising effect of the content.

For example, in a technique disclosed in PTL 1, attributes such as age and sex of a person whose image is captured by using the imaging apparatus are estimated, and a content to be presented to the person is selected on the basis of the estimated attributes.

### CITATION LIST

### Patent Literature

[PTL 1] Japanese Unexamined Patent Application Publication No. 2003-271084 A

### SUMMARY OF INVENTION

### Technical Problem

Incidentally, in a case where a digital signage is installed in stores, public facilities, and the like, an employee, a cleaning staff, a security guard, or the like (hereinafter also referred to as “employees”) may be engaged in works near the digital signage. In other words, employees may stay for any duration within a range in which an imaging apparatus captures an image. In general, for a digital signage installed in stores, public facilities, and the like, employees are often not target people to whom contents are to be presented.

In the technique disclosed in PTL 1, a content to be presented to an imaged person is selected without distinguishing the person. Therefore, when employees are located near the digital signage, a content based on attributes of the employees is selected and output, thereby there is a possibility that the digital signage cannot effectively perform advertisement.

The present disclosure has been made in view of the above-described problem, and a main object of the present disclosure is to provide a content selection apparatus, a content selection method, a program, and the like that select a content with a high advertising effect.

### Solution to Problem

A content selection apparatus according to an aspect of the present invention includes an extraction means for extracting, from image data, information about a feature of a person included in the image data, a determination means for determining, based on the extracted information, whether a person included in the image data is a non-target, which is a person who is not a target to which a content is presented, and a selection means for selecting a content, based on information about a person determined not to be a non-target by the determination means from among the information extracted by the extraction means.

A content selection method according to an aspect of the present invention includes extracting, from image data, information about a feature of a person included in the image data, determining, based on the extracted information, whether a person included in the image data is a non-target, which is a person who is not a target to which a content is presented, and selecting a content, based on a result of the determination.

A program according to an aspect of the present invention causes a computer to execute processing of extracting, from image data, information about a feature of a person included in the image data, processing of determining, based on the extracted information, whether a person included in the image data is a non-target, which is a person who is not a target to which a content is presented, and processing of selecting a content, based on a result of the determination.

### Advantageous Effects of Invention

According to the present disclosure, an advantage of being able to select a content with a high advertising effect can be obtained.

### BRIEF DESCRIPTION OF DRAWINGS

FIG. 1 is a block diagram illustrating an example of a hardware configuration of a computer apparatus that achieves a content selection apparatus in each example embodiment.

FIG. 2 is a figure illustrating an example of a configuration of a content selection system according to a first example embodiment.

FIG. 3 is a block diagram illustrating an example of a functional configuration of the content selection system according to the first example embodiment.

FIG. 4 is a figure illustrating an example of non-target information according to the first example embodiment.

FIG. 5 is a diagram illustrating another example of non-target information according to the first example embodiment.

FIG. 6 is a figure illustrating an example of content identification information according to the first example embodiment.

FIG. 7 is a figure illustrating an example of target attribute information according to the first example embodiment.

FIG. 8 is a flowchart explaining operation of a content information acquiring unit according to the first example embodiment.

FIG. 9 is a flowchart for explaining operation of a non-target information registering unit according to the first example embodiment.

FIG. 10 is a flowchart for explaining operation of a content selection system according to the first example embodiment.

FIG. 11 is a figure illustrating an example of extraction information according to the first example embodiment.

FIG. 12 is a block diagram illustrating an example of a functional configuration of a content selection system according to a first modification of the first example embodiment.

FIG. 13 is a block diagram illustrating an example of a functional configuration of a content selection system according to a second modification of the first example embodiment.

FIG. 14 is a block diagram illustrating an example of a functional configuration of a content selection apparatus according to a second example embodiment.

FIG. 15 is a figure illustrating an example of person information according to the second example embodiment.

FIG. 16 is a figure illustrating an example of a minimum configuration of a content selection apparatus according to a third example embodiment.

FIG. 17 is a flowchart for explaining operation of the content selection apparatus according to the third example embodiment.

### EXAMPLE EMBODIMENT

### First Example Embodiment

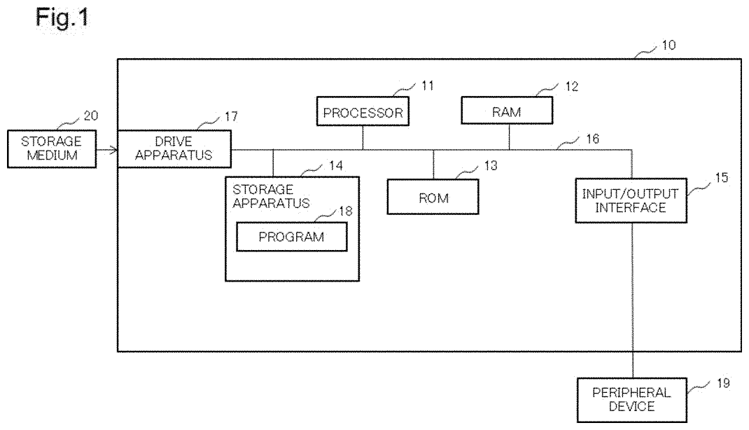

Hardware constituting a content selection apparatus according to first example embodiment and other example embodiments will be described. FIG. 1 is a block diagram illustrating an example of a hardware configuration of a computer apparatus that achieves a content selection apparatus in each example embodiment. Each block illustrated in FIG. 1 can be achieved by any combination of software and a computer apparatus 10 that achieves a content selection apparatus and a content selection method according to each example embodiment.

As illustrated in FIG. 1, the computer apparatus 10 includes a processor 11, a random access memory (RAM) 12, a read only memory (ROM) 13, a storage apparatus 14, an input/output interface 15, and a bus 16.

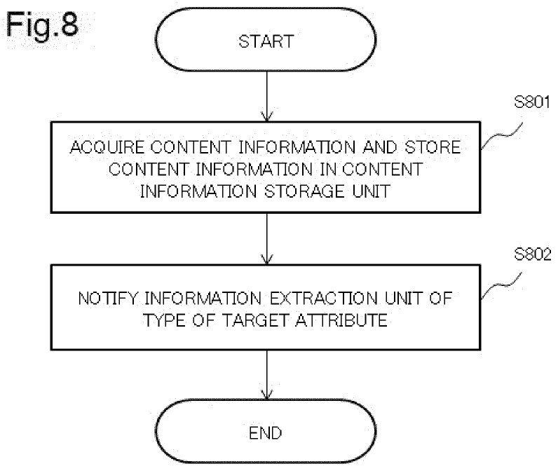

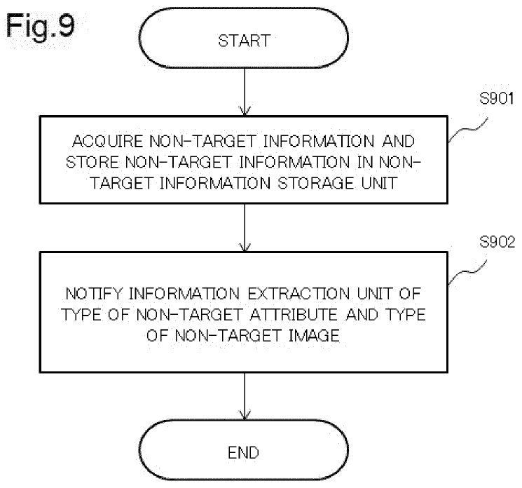

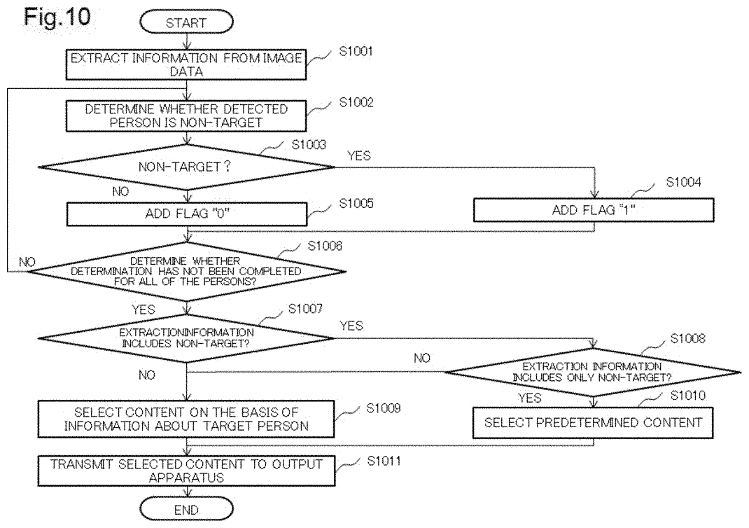

The storage apparatus 14 stores a program 18. The processor 11 uses the RAM 12 to execute the program 18 related to the content selection apparatus. Specifically, for example, the program 18 includes a program that causes a computer to execute the processes illustrated in FIG. 8, FIG. 9, and FIG. 10. The functions of each of constituent elements of this content selection apparatus (an information extraction unit 110, a non-target determination unit 120, a content selection unit 130, a non-target information management unit 140, a content information acquiring unit 160, explained later) are achieved by causing the processor 11 to execute the program 18. The program 18 may be stored in the ROM 13. The program 18 may be recorded in the recording medium 20 and read by the drive apparatus 17 or may be transmitted from an external apparatus via a network.

The input/output interface 15 exchanges data with peripheral devices (a keyboard, a mouse, a display apparatus, and he like) 19. The input/output interface 15 functions as a means for acquiring or outputting data. The bus 16 connects each constituent element.

There are various modifications for methods for realizing the content selection apparatus. For example, the content selection apparatus can be achieved as a dedicated apparatus. The content selection apparatus can be achieved by a combination of a plurality of apparatuses.

A processing method for recording in a recording medium a program for realizing each constituent element in the functions of the present example embodiment and other example embodiments, reading the program recorded in the recording medium as a code, and causing a computer to execute the code is also included in the scope of each example embodiment. That is, a computer-readable recording medium is also included in the scope of each example embodiment. In addition to the recording medium in which the above program is recorded, the program itself is included in each example embodiment

For example, a floppy (registered trademark) disk, a hard disk, an optical disk, a magneto-optical disk, a CD (Compact Disc)-ROM, a magnetic tape, a nonvolatile memory card, and a ROM can be used as the recording medium. In addition, not only those that execute processing with a program itself recorded in the recording medium, but those that run on an OS (Operating System) in collaboration with functions of other software and expansion boards are also included in the scope of each example embodiment.

Next, overview of each example embodiment of the content selection system that constitutes a digital signage will be explained.

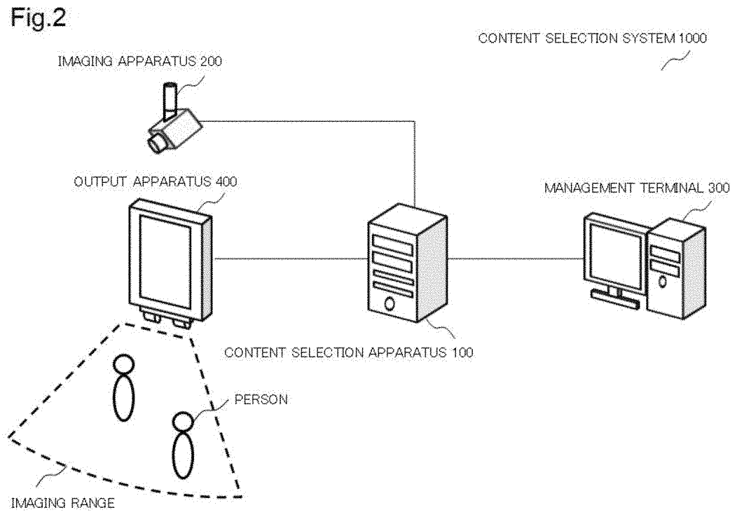

FIG. 2 is a figure illustrating an example of a configuration of a content selection system according to the first example embodiment. As illustrated in FIG. 2, a content selection system 1000 includes a content selection apparatus 100, an imaging apparatus 200, a management terminal 300, and an output apparatus 400. The content selection system 1000 is a system in which the output apparatus 400 outputs a content based on at least control of the content selection apparatus 100.

The content selection apparatus 100 is connected to the imaging apparatus 200, the management terminal 300, and the output apparatus 400 so as to be able to communicate with each other.

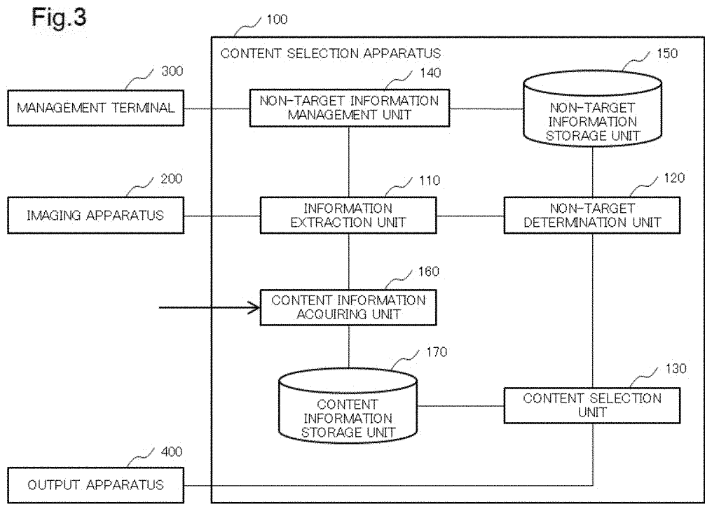

FIG. 3 is a block diagram illustrating an example of a functional configuration of the content selection system 1000 illustrated in FIG. 2. Each block in the content selection apparatus 100 illustrated in FIG. 3 may be implemented in a single apparatus or may be implemented in a plurality of apparatuses. Data exchange between the blocks may be performed through any means such as a data bus, a network, a portable storage medium, and the like.

As illustrated in FIG. 3, the content selection apparatus 100 includes an information extraction unit 110, a non-target determination unit 120, a content selection unit 130, a non-target information management unit 140, a non-target information storage unit 150, a content information acquiring unit 160, and a content information storage unit 170. The content selection apparatus 100 has a function of selecting a content output by the output apparatus 400 using information obtained from the imaging apparatus 200 and the management terminal 300.

The imaging apparatus 200 is an apparatus capturing images in a predetermined range. The range in which the imaging apparatus 200 captures imagines is referred to as “imaging range”. In FIG. 2, a range indicated by a dotted line in front of the output apparatus 400 is defined as an “imaging range”. The imaging apparatus 200 captures images in the imaging range and transmits generated image data to the content selection apparatus 100.

The management terminal 300 is an information processing apparatus provided with input/output means for managing the content selection system 1000. The management terminal 300 may be a personal computer, for example. The management terminal 300 transmits information for identifying a non-target to the content selection apparatus 100.

The output apparatus 400 is a signage terminal that displays a content such as images and characters on a flat display or projector. The output apparatus 400 obtains the selected content from the content selection apparatus 100 and outputs the selected content to a flat display or the like.

In FIG. 2 and FIG. 3, the content selection apparatus 100 is illustrated as an independent apparatus, but is not limited thereto. That is, for example, the content selection apparatus 100 may be included in the output apparatus 400. Further, the content selection apparatus 100 may be included in an apparatus in which the imaging apparatus 200 and the output apparatus 400 are integrated. The content selection apparatus 100 may be constructed in an on-premises environment or a cloud environment. Next, each constituent element of the content selection apparatus 100 will be described.

The information extraction unit 110 acquires image data from the imaging apparatus 200, detects a person included in the image data, and extracts information about the characteristics of the detected person. The information about the characteristics of the person is the attribute of the detected person, the image of the person extracted from the image data, and the like. The information extraction unit 110 extracts information about the characteristics of the person from the image data. Hereinafter, the information related to the characteristics of the person extracted by the information extraction unit 110 is referred to as “extraction information”. In the extraction information, the attribute of person is referred to as “extraction attribute”, and the image of the person extracted from the image data is referred to as “extraction image”. The extraction attribute is, for example, person's sex, age, height, posture, presence or absence of glasses, presence or absence of beard, and luggage held by the person, but is not limited thereto. The extracted image is, for example, an image obtained by extracting a face portion or a clothing portion of the person in the image data in a rectangular area, but is not limited thereto. The information extraction unit 110 corresponds to extraction means for extracting information about the characteristics of the person included in the image data from the image data.

The non-target determination unit 120 determines whether the person included in the image data is a non-target on the basis of extraction information and non-target information (details of which will be described later) stored in the non-target information storage unit 150. Here, in the present example embodiment, an unspecified person such as a passerby or a customer is considered as a target for presenting a content. A non-target is a person that is not treated as a target for presenting a content. The non-target is set in advance. The non-target is a person who is engaged in a work near the imaging range, such as employees, cleaners, guards, and the like. The non-target determination unit 120 corresponds to determination means for determining whether a person included in the image data is a non-target based on the extracted information.

The content selection unit 130 selects a content to be output by the output apparatus 400 according to a determination result of the non-target determination unit 120. The content selection unit 130 corresponds to the selection means for selecting a content from the extracted information on the basis of information about a person determined not to be a non-target.

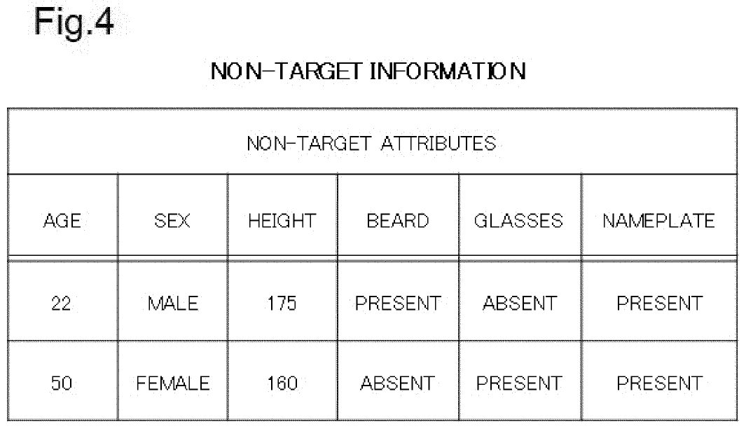

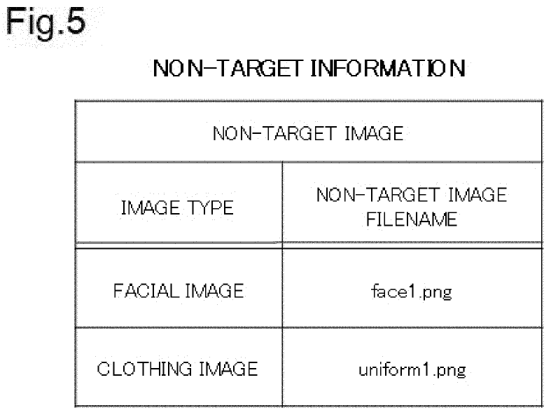

The non-target information management unit 140 registers the non-target information acquired from the management terminal 300 in the non-target information storage unit 150. FIG. 4 and FIG. 5 are diagrams each illustrating an example of non-target information. The non-target information is information about a person who is not the target for presenting a content. FIG. 4 illustrates non-target information including non-target attributes indicating an attribute of a person who is set as a non-target. In FIG. 4, “age”, “sex”, “height”, “(presence or absence of) beard”, “(presence or absence of) glasses” and “(presence or absence of) nameplate” are used as non-target attribute types. However, the non-target attribute types are not limited thereto. FIG. 5 illustrates non-target information including a non-target image indicating an image of a person that is set as a non-target. Although FIG. 5 uses “clothing image” and “face image” as a non-target image type, the non-target image type is not limited thereto. Here, the clothing image is, for example, an image of a uniform of a store employee, a cleaner, and a security guard that is set as a non-target, but the clothing image is not limited thereto. The clothing image may be, for example, an individual clothing image of a person that is set as a non-target. The face image is, for example, an image of a person's face that is set as a non-target. The non-target information includes at least one of a non-target attribute and a non-target image.

The content information acquiring unit 160 acquires content information (details of which will be described later) and stores the content information in the content information storage unit 170. The present example embodiment employs a configuration in which the content information acquiring unit 160 acquires the content information from a server or the like (not illustrated) connected to the content selection apparatus 100 via a network, but is not limited thereto. For example, the content information acquiring unit 160 may acquire the content information from a memory card inserted in the content selection apparatus 100, a USB (Universal Serial Bus) memory, or the like.

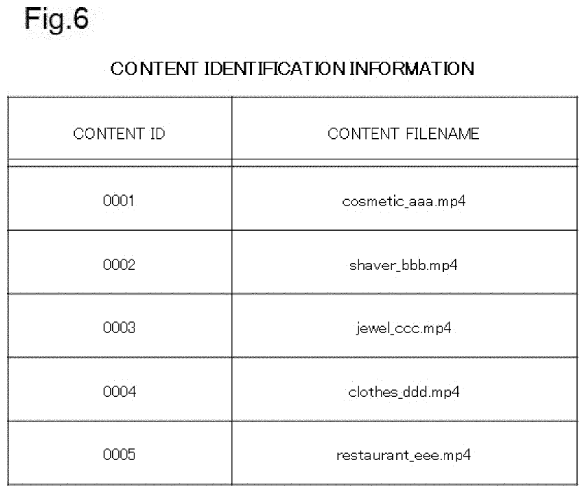

The content information storage unit 170 holds content information. The content information includes actual data of a content, information for identifying the content, and information about an attribute of a person that is a target of the content. Hereinafter, the actual content data will be referred to as the “content file”, the information that identifies content will be referred to as “content identification information”, and the information about the attribute of the person that is the target of the content will be referred to as “target attribute information”. FIG. 6 is a figure illustrating an example of content identification information. As illustrated in FIG. 6, the content identification information is information that associates a content identification (ID) and a content file name for identifying the content. For example, a content ID of a content file whose content file name is “cosmetic_aaa.mp4” is “0001”.

The content information acquiring unit 160 and the content information storage unit 170 may be connected to the outside of the content selection apparatus 100 or may be included in the content selection unit 130.

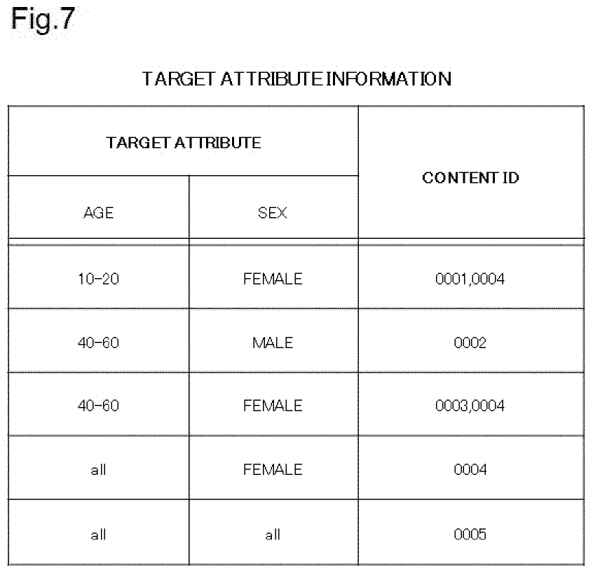

FIG. 7 illustrates an example of target attribute information. As illustrated in FIG. 7, the target attribute information includes a target attribute and a content ID. The target attribute is an attribute of a person who is a main target of a content. The main target is a person for which a high content appeal effect (advertising effect) is considered to be obtained. In the target attribute information, for each target attribute. a content ID of a content of which main target is a person having the attribute is associated. Content IDs of contents of which main targets are persons whose ages are “10 to 20” years old and whose sexes are “female” are “0001” and “0004”. Here, a content whose age or sex is “all” indicates that the age or the sex is not specified as the main target. In FIG. 7, the age and the sex are used as the target attributes, but the target attribute is not limited thereto. For example, height, posture, presence or absence of glasses, presence or absence of beard, luggage held by the person, and the like may be used as the target attribute.

Next, the operation of the content selection system 1000 will be described. The content selection system 1000 according to the present example embodiment captures images in the imaging range, and performs processing to select a content on the basis of the information extracted from the generated image data. The content selection apparatus 100 acquires content information and non-target information in advance. The content selection apparatus 100 uses the acquired content information and the acquired non-target information to determine information to be extracted from the image data. First, the operation in which the content selection apparatus 100 acquires content information and non-target information by the content selection system 1000 will be described. Hereafter, in this specification, each step of the flowchart is expressed by using the number assigned to each step, such as “S801”.

FIG. 8 is a flowchart for explaining operation for acquiring content information by the content information acquiring unit 160. First, the content information acquiring unit 160 acquires content information from a server or the like connected to the content selection apparatus 100 via a network. Here, it is assumed that the content information acquiring unit 160 has acquired content identification information and a content file indicated in the content identification information illustrated in FIG. 6 and target attribute information illustrated in FIG. 7. The content information acquiring unit 160 stores the acquired content information in the content information storage unit 170 (S801). Then, the content information acquiring unit 160 notifies the information extraction unit 110 of the type of the target attribute included in the target attribute information (S802). In the example of FIG. 7, the content information acquiring unit 160 notifies the information extraction unit 110 of “age” and “sex”.

FIG. 9 is a flowchart for explaining operation for acquiring non-target information by the non-target information management unit 140. First, the non-target information management unit 140 acquires non-target information from the management terminal 300. Here, it is assumed that the non-target information illustrated in FIG. 4 and FIG. 5 is acquired. The non-target information management unit 140 stores the acquired non-target information in the non-target information storage unit 150 (S901). Then, the non-target information management unit 140 notifies the information extraction unit 110 of the type of the non-target attribute and the type of the non-target image included in the non-target information (S902). In the example of FIG. 4 and FIG. 5, the non-target information management unit 140 notifies the information extraction unit 110 of “sex”, “age”, “height”, presence or absence of “beard”, presence or absence of “glasses”, presence or absence of “nameplate”, “clothes image”, and “facial image”.

The type of the target attribute, the type of the non-target attribute, and the type of the non-target image notified to the information extraction unit 110 in S802 and S902 are used to instruct the information extraction unit 110 to extract information from image data (details of which will be described later). Hereinafter, information used to instruct information to be extracted from image data is referred to as “extraction instruction information”.

Next, processing in which the content selection system 1000 captures images in the imaging range and selects a content on the basis of the information extracted from the generated image data will be described. FIG. 10 is a flowchart for explaining the operation of the content selection system 1000 according to the present example embodiment.

The content selection apparatus 100 acquires image data from the imaging apparatus 200. Based on the extraction instruction information, the information extraction unit 110 extracts information about the person, that is, the above-described extraction information from the image data at a predetermined timing (S1001).

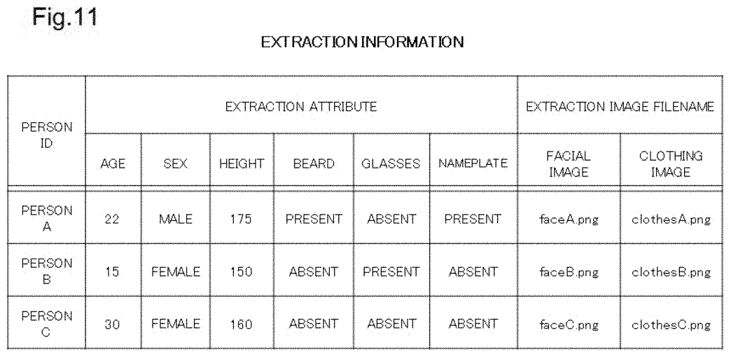

FIG. 11 illustrates an example of extraction information. When the extraction instruction information indicates the type of a target attribute or the type of a non-target attribute, the information extraction unit 110 extracts the attribute corresponding to the type of each attribute for the person included in the image data. In the example of FIG. 11, the information extraction unit 110 extracts extraction attribute indicating person's “sex”, “age”, “height”, presence or absence of “beard”, presence or absence of “glasses”, presence or absence of “nameplate” of the person included in image data. When the extraction instruction information indicates the type of the non-target image, the information extraction unit 110 extracts an image corresponding to the type of the image from the image data. In the example of FIG. 11, the information extraction unit 110 extracts the extraction image indicating a “facial image” and a “clothing image” of the person extracted from the image data. The “person ID” illustrated in FIG. 11 is information given to identify the person included in the image data.

As described above, the content selection apparatus 100 extracts extraction information from image data at a predetermined timing. Here, the predetermined timing may be a regular interval of time or may be a point in time defined in advance, but is not limited thereto. For example, in a case where the content selection apparatus 100 selects a next content to be output while the output apparatus 400 is outputting a content, the content selection apparatus 100 may extract information from the image data at an interval according to the length of time in which the content is output by the output apparatus 400. In the present example embodiment, the information extraction unit 110 acquires the extraction instruction information from the content information acquiring unit 160 and non-target information management unit 140 in advance and determines the information to be extracted from the image data, but the present example embodiment is not limited thereto. For example, the information extraction unit 110 may read the extraction instruction information from the non-target information storage unit 150 and the content information storage unit 170 at the predetermined timing described above. At this time, the information extraction unit 110 may be directly connected to the non-target information storage unit 150 and the content information storage unit 170.

Back to FIG. 10, the non-target determination unit 120 determines whether the detected person is a non-target on the basis of the extraction information acquired from the information extraction unit 110 and the non-target information stored in the non-target information storage unit 150 (S1002). Here, the non-target determination unit 120 determines whether each of a person A, a person B, and a person C illustrated in FIG. 11 is a non-target.

Here, various methods can be considered as a method for determining whether the target is a non-target. For example, the extraction image included in the extraction information is collated with a non-target image included in non-target information. As a result of the collation, in a case where the face and clothing included in these images are determined to be the same, the non-target determination unit 120 may determine that the detected person is a non-target. Various known image collation techniques can be used for image collation. Examples of usable methods include a method for extracting feature points such as edges from an image and collating images on the basis of a positional relationship in the feature points between the images or a method for adopting a non-target image as a template image, overlaying the extraction image on the template image, and searching for similar regions. Also, the extraction attribute included in the extraction information is compared with the non-target attribute included in the non-target information, and in a case where the attributes match, the detected person may be determined to be a non-target. At this time, a threshold value of a matching ratio may be determined in advance, and in a case where the attribute matches at a ratio equal to or more than the threshold value, the detected person may be determined to be a non-target. For example, in a case where the threshold value is ⅔, in the example of FIG. 4 and FIG. 11, in a case where 4 or more types out of 6 types of attributes match, the detected person may be determined to be a non-target.

In the present example embodiment, as non-target information, both the non-target attribute illustrated in FIG. 4 and the non-target image illustrated in FIG. 5 may be acquired, or only one of them may be acquired. For example, in a case where only a non-target image is acquired as non-target information, only image collation may be performed to determine whether the detected person is a non-target. In addition, in a case where both non-target attribute and non-target image are acquired as non-target information, both of the image collation and the attribute comparison may be performed. By performing both collation of images and comparison of attributes, it is possible to determine whether the detected person is a non-target even in a case where a determination can be made uniquely with only one of them. That is, the accuracy of determination can be improved.

In a case where the detected person is determined to be a non-target (“YES” in S1003), the non-target determination unit 120 adds a flag “1” to a record of the person in the extraction information (S1004). In addition, in a case where the detected person is determined not to be a non-target, that is, the person is determined not to be a target (“NO” in S1003), the non-target determination unit 120 adds a flag “0” to a record of the person in the extraction information (S1005). For example, the extraction attribute of the “person A” illustrated in FIG. 11 matches all the non-target attributes illustrated in FIG. 4. In this case, the non-target determination unit 120 determines that the “person A” is a non-target and adds a flag “1” to a record of the “person A” in the extraction information.

The non-target determination unit 120 checks whether the determination has been completed for all of the persons included in the extraction information after the processing of S1004 or S1005. Specifically, the non-target determination unit 120 checks whether there is a record with no flag added to the extraction information. The non-target determination unit 120 determines that the determination has not been completed for all of the persons in a case where there is a record with no flag added, and the non-target determination unit 120 determines that the determination has been completed in a case where there is no record without any flag added.

In a case where the determination has not been completed for all of the persons included in the extraction information (“YES” in S1006), the non-target determination unit 120 determines whether a person for which determination has not been completed is a non-target or not. The non-target determination unit 120 repeats the processing from S1002 to S1005 until the determination for all of the persons included in the extraction information is completed. In the present example embodiment, it is assumed that the non-target determination unit 120 determines that the “person A” of the extraction information illustrated in FIG. 11 is a non-target and that the “person B” and “person C” are not non-targets. In other words, a flag “1” is added to the “person A” in the extraction information, and a flag “0” is added to the “person B” and “person C”.

The non-target determination unit 120 adds a flag to items of all of the person items included in the extraction information (“NO” in S1006), and transmits the extraction information to the content selection unit 130.

In a case where the extraction information includes only a person who is a target (“NO” in S1007), and in a case where the extraction information includes a non-target (“YES” in S1007 and “NO” in S1008), the content selection unit 130 selects a content on the basis of information about the target person from the extraction information (S1009). Specifically, the content selection unit 130 selects a content that matches the attribute of the person having a flag “0” added thereto in the extracted information from the target attribute information stored in the content information storage unit 170. In the example of FIG. 11, a content that matches the attributes of the “person B” and the “person C” is selected. For example, the “person B” has an age of “15” and a sex of “female”. At this time, the content selection unit 130 selects, out of the target attribute information illustrated in FIG. 7, contents having content IDs “0001” and “0004” for persons whose ages are “10 to 20” years old and whose sexes are “female”. The “person C” has an age of “30” and a sex of “female”. For the “person C”, there is no content that specifies an age of “30” for the target attribute information. At this time, the content selection unit 130 selects a content of a content ID “0004” for a target attribute of which age is “all” and of which sex is “female”.

In a case where the extraction information does not include a target person, i.e., in a case where the extraction information includes only the person that has been determined to be a non-target (“YES” in S1008), the content selection unit 130 selects a content without considering the extraction information (S1010). For example, a content that does not specify a target attribute, i.e., a content of a content ID “0005” of which both of age and sex are “all”, is selected.

The method for selecting a content is not limited to the above example. For example, the extraction information used when selecting a content may be selected according to the distance between the signage terminal and each person, the direction of gaze of each person, and the like. Specifically, the distance between the signage terminal and each person may be measured, and a content may be selected using the information about the person a distance to which is the shortest from among the extraction information to which flags are added. In addition, the gaze and the face orientation of each person may be determined, and a content may be selected using the information about the person who has been determined to be viewing the signage terminal from among the extraction information to which flags are added.

The content selection unit 130 transmits the content file of the selected content to the output apparatus 400 (S1010). Here, the content files with the content IDs “0001” and “0004” are sent to the output apparatus 400. The output apparatus 400 plays the contents using the received content files and outputs the contents to a flat display or the like. At this time, for example, the output apparatus 400 may output one of the two contents, or may output the two contents in order. By outputting the contents in order, the same contents can be output in a shorter time.

As described above, the content selection apparatus 100 according to the first example embodiment determines whether the person included in the image data is a non-target on the basis of the extraction information obtained from the image data. The content selection apparatus 100 selects a content to be output by the output apparatus 400 on the basis of the result of the determination. As a result, the content can be selected by excluding the information about the non-target, so that the effect of selecting a content with high advertising effect can be obtained.

### First Modification

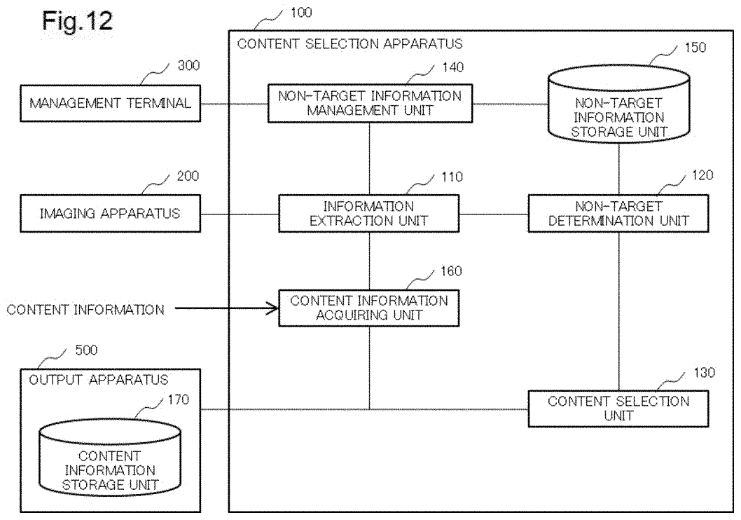

FIG. 12 is a block diagram illustrating an example of a functional configuration of the content selection system 1000 according to the first modification. As illustrated in FIG. 12, the content information storage unit 170 may be in the output apparatus 500. At this time, the content information acquiring unit 160 is communicably connected to the output apparatus 500.

The content information acquiring unit 160 acquires content information and stores the acquired content information in the content information storage unit 170 in the output apparatus 500.

The content selection unit 130 selects a content based on the determination result of the non-target determination unit 120 and transmits the content ID of the selected content to the output apparatus 500.

The output apparatus 500 searches the content information storage unit 170 for a content file corresponding to the content ID received from the content selection unit 130, and outputs the content.

In this way, in this modification, the content that the output apparatus holds in advance is played back. Therefore, the content can be output stably.

### Second Modification

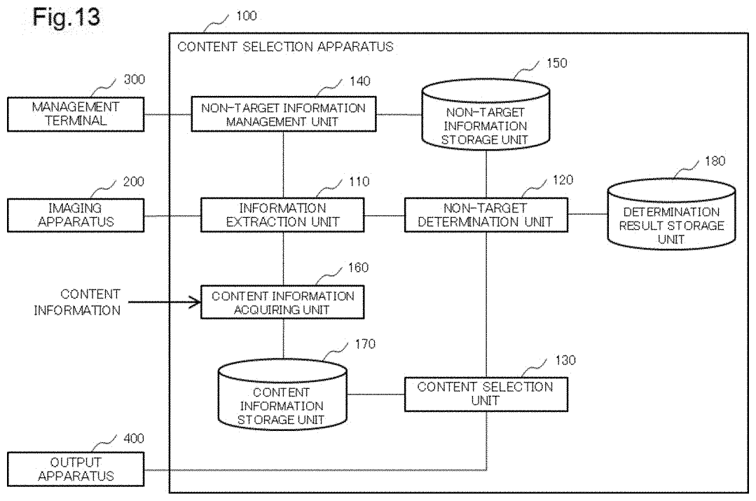

FIG. 13 is a block diagram illustrating an example of a functional configuration of a content selection system 1000 according to a second modification. As illustrated in FIG. 13, the content selection apparatus 100 may further include a determination result storage unit 180.

The determination result storage unit 180 is connected to the non-target determination unit 120. The non-target determination unit 120 stores, in the determination result storage unit 180, information obtained by associating a result of determination as to whether a person included in image data is a non-target or not, i.e., extraction information having a flag added thereto, and time information. At this time, the information stored in the non-target determination unit 120 is not limited thereto. For example, the non-target determination unit 120 may store extraction information and time information excluding information about persons determined to be non-target. Further, the non-target determination unit 120 may associate, with extraction information, a content ID of a content output at the time when the person included in image data is detected. That is, the determination result storage unit 180 corresponds to storage means for storing information associating extracted information, a result of determination as to whether a person included in image data is a non-target or not, and a time when the person included in the image data is detected.

With this configuration, in this modification, extraction information can be used as statistical data used in various analyses. For example, by extracting, as extraction information, information indicating whether a detected person has viewed a signage terminal, an attribute of the person interested in a content can be acquired from the extraction information. Therefore, the extraction information can be used to predict what attribute each content has for a person with a high advertising effect. In addition, from the extracted information, attributes of passers-by near the digital signage can be obtained at predetermined intervals. Therefore, the extraction information can be used to predict whether a person with a specific attribute will pass near the digital signage in the same time zone at a later date.

Furthermore, in this modification, extraction information reflecting a result of determination as to whether a person is a non-target or not is generated and stored, and therefore, only a person who is not a non-target, i.e., information about a target person, can be used for analysis. Therefore, for example, in the prediction described above, information about non-target attributes can be removed in advance, so that extraction information can be used as more accurate statistical data.

### Second Example Embodiment

In the second example embodiment, an example in which non-target information is registered based on information extracted from image data will be described.

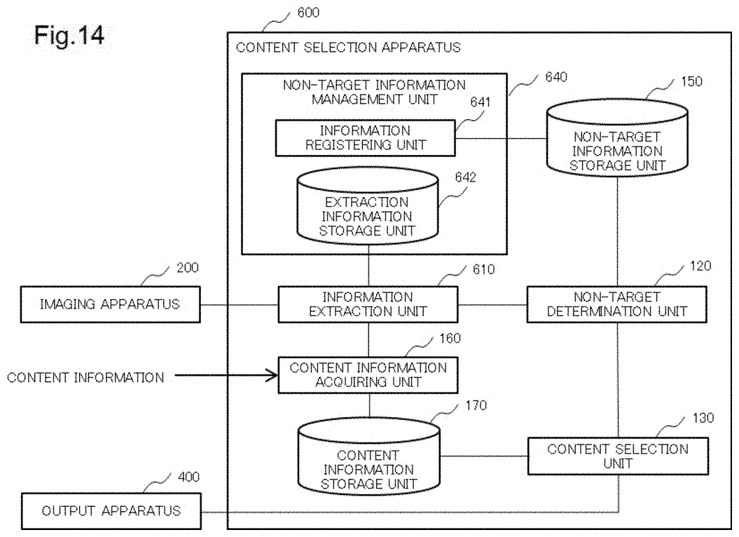

FIG. 14 is a block diagram illustrating an example of a configuration of a content selection apparatus 600 according to the present example embodiment. The configuration of the content selection system according to the present example embodiment is the same as the configuration of the content selection system illustrated in FIG. 3 except for an information extraction unit and a non-target information management unit. Hereinafter, explanation about contents overlapping the explanation in the first example embodiment will be omitted. The content selection apparatus 600 includes an information extraction unit 610, a non-target determination unit 120, a content selection unit 130, a non-target information management unit 640, a non-target information storage unit 150, a content information acquiring unit 160, and a content information storage unit 170. The non-target information management unit 640 includes an information registering unit 641 and an extraction information storage unit 642. The non-target determination unit 120, the content selection unit 130, the non-target information storage unit 150, the content information acquiring unit 160, and the content information storage unit 170 have configurations similar to the configurations in the first example embodiment, and accordingly, detailed explanation will be omitted.

The present example embodiment explains that the non-target information management unit 640 determines whether the person is a non-target or not on the basis of appearance frequency of persons included in the extraction information, and registers information about the person determined to be the non-target to the non-target information storage unit 150.

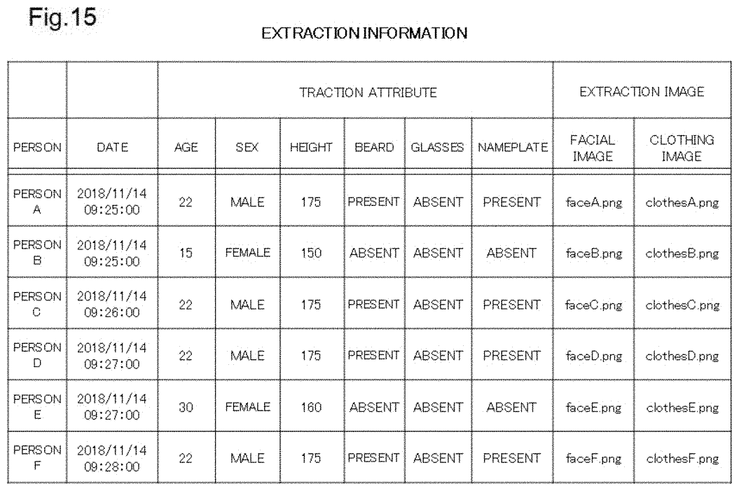

The information extraction unit 610 stores the extraction information to the extraction information storage unit 642. FIG. 15 is a figure illustrating an example of extraction information stored in the extraction information storage unit 642 according to the present example embodiment.

When extraction information is stored in the extraction information storage unit 642, the information registering unit 641 determines whether the stored extraction information includes information of a person as a non-target. Specifically, the information registering unit 641 calculates an appearance frequency of the same person at every predetermined time, and determines a person with a high appearance frequency as a non-target. For example, the predetermined time is set to 3 minutes, and a threshold value for the appearance frequency is set to 3. In other words, a person with an appearance frequency of 3 or more within 3 minutes is determined to be a non-target. In the example of FIG. 15, the attributes of a person A, a person C, a person D, and a person F are age “22”, sex “male”, height “175”, beard “present”, glasses “absent”, and nameplate “present”, and all of the six types of attributes are in agreement. Therefore, the person A, the person C, the person D, and the person F are determined to be the same person. At this time, the appearance frequency of the person is 4, which exceeds the threshold value of 3. Therefore, the information about the person is determined to be non-target information. The information registering unit 641 stores the information about the person in the extracted information to the non-target information storage unit 150 and registers the information as non-target information. The non-target determination unit 120 can determine whether the person included in the image data is non-target or not by using the registered non-target information.

Here, the method for determining whether a person is non-target or not is not limited to the method described above. For example, a person included in the image data may be extracted as extraction information as a time during which the person stays in the imaging range (stay time), and a person whose stay time is equal to or more than the threshold value may be determined to be a non-target.

The information registering unit 641 corresponds to non-target information management means for determining whether a person is a non-target on the basis of an appearance frequency in image data of a person related to extracted information, and adopting the information about the features of the person as non-target information in a case where the person is determined to be a non-target.

As described above, the content selection apparatus 600 according to the present example embodiment determines whether a person is a non-target or not by using at least one of the appearance frequency and the stay time of the person included in the extraction information, and registers information about the person determined to be a non-target as non-target information. As a result, non-target information can be automatically generated, so that labor and time required for registration of non-target information can be reduced.

### Third Example Embodiment

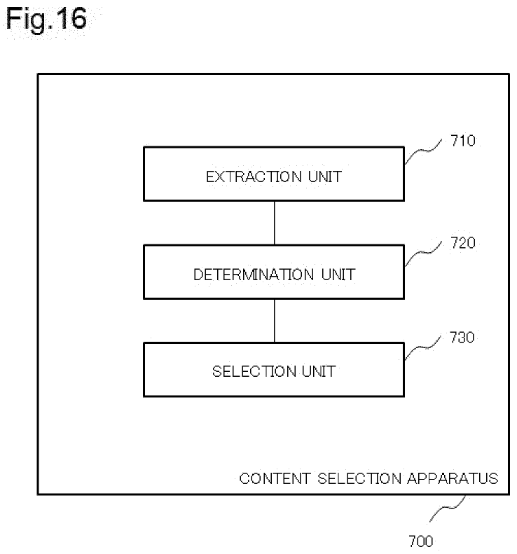

FIG. 16 is a block diagram illustrating an example of a content selection apparatus 700 according to the third example embodiment of the present invention. As illustrated in FIG. 16, the content selection apparatus 700 includes an extraction unit 710, a determination unit 720, and a selection unit 730. The configurations of the extraction unit 710, the determination unit 720, and the selection unit 730 are similar to the information extraction unit 110, the non-target determination unit 120, and the content selection unit 130, respectively, according to the first example embodiment. Therefore, detailed explanation thereabout is omitted.

The extraction unit 710 extracts information about persons from image data.

The determination unit 720 determines whether a person included in image data is a non-target or not on the basis of information extracted by the extraction unit 710.

The selection unit 730 selects a content on the basis of information about a person determined not to be a non-target by the determination unit 720 among the extracted information.

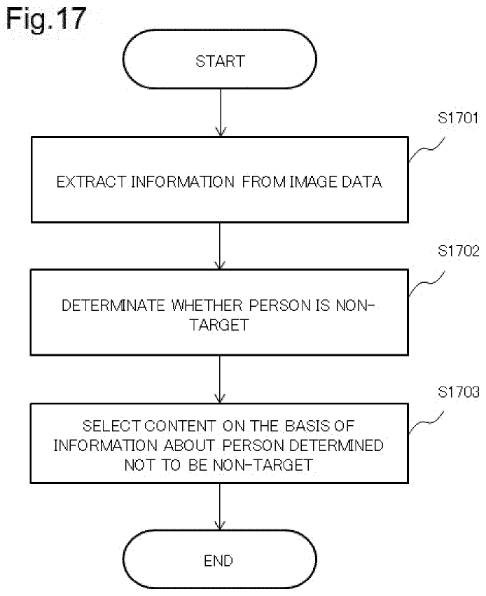

Next, the operation of the content selection apparatus 700 will be described. FIG. 17 is a flowchart for explaining operation of the content selection apparatus 700 according to the present example embodiment.

When the image data is obtained, the extraction unit 710 extracts information about features of a person included in image data from image data (S1701). At this time, the extraction unit 710 may acquire image data from an imaging apparatus or the like (not illustrated) connected to the content selection apparatus 700 via a network.

The determination unit 720 determinates whether a person included in image data is a non-target that is not a target to which a content is to be presented, on the basis of the information about the features of the person extracted by the extraction unit 710 (S1702).

The selection unit 730 selects a content on the basis of the information about the features of the person determined not to be a non-target among the information about the features of the person extracted by the extraction unit 710 (S1703). At this time, the selection unit 730 may acquire the content from a server (not illustrated) connected to the content selection apparatus 700 via a network a memory card or a USB memory inserted into the content selection apparatus 100, or the like. Alternatively, the selection unit 730 may acquire a content in advance or may acquire the content in S1703.

As described above, according to the content selection apparatus 700 according to the present example embodiment, it is possible to select a content by excluding non-target information, so that it is possible to select the content with high advertising effect.

The present invention has been described above with reference to the aforementioned implementation. However, the present invention is not limited to the above-described example embodiment. That is, the present invention can be applied to various modes that can be understood by those skilled in the art, such as various combinations and selections of the various disclosed elements, within the scope of the present invention.

### REFERENCE SIGNS LIST

10 computer apparatus

11 processor

12 RAM

13 ROM

14 storage apparatus

15 input/output interface

16 bus

17 drive apparatus

18 program

19 peripheral device

20 recording medium

1000 content selection system

100, 600, 700 content selection apparatus

110, 610 information extraction unit

120 non-target determination unit

130 content selection unit

140, 640 non-target information management unit

150 non-target information storage unit

160 content information acquiring unit

170 content information storage unit

180 determination result storage unit

200 imaging apparatus

300 management terminal

400, 500 output apparatus

641 information registering unit

642 extraction information storage unit

710 extraction unit

720 determination unit

730 selection unit

1.-10. (canceled)

11. A content selection apparatus comprising:
at least one memory configured to store instructions; and
at least one processor configured to execute the instructions to:
extract, from image data, a first information about a feature of a person included in the image data;
determine, based on the first information, whether the person is a non-target, the non-target being a person who is not a target to which a content is presented; and
select a content, based on a second information about a person determined not to be a non-target, the first information including the second information.

12. The content selection apparatus according to claim 11, wherein the at least one processor is configured to execute the instructions to:
determine whether the person included in the image data is a non-target, based on the first information and a predetermined information about the non-target.

13. The content selection apparatus according to claim 12, wherein the at least one processor is configured to execute the instructions to:
determine whether the person is a non-target, based on an appearance frequency in the image data of a person related to the extracted information,
the predetermined information being information about a feature of the person determined to be a non-target.

14. The content selection apparatus according to claim 11, wherein the at least one processor is configured to execute the instructions to:
select a content, based on a third information about a feature of the person, in a case where the extracted information includes information about a feature of a person determined not to be a non-target, and
select a predetermined content, in a case where the first information does not include the third information.

15. The content selection apparatus according to claim 11, wherein the feature comprises an attribute of a person included in the image data.

16. The content selection apparatus according to claim 15, wherein the attribute includes at least one age, sex, height, presence or absence of beard, presence or absence of glasses, or presence or absence of a nameplate of a person included in the image data.

17. The content selection apparatus according to claim 11, wherein the at least one processor is configured to execute the instructions to:
store information associating the first information, a result of determination as to whether a person included in the image data is a non-target, and a time when a person included in the image data is detected.

18. A content selection system comprising:
the content selection apparatus according to claim 11;
an imaging apparatus generating the image data; and
an output apparatus outputting the content.

19. A content selection method comprising:
extracting, from image data, a first information about a feature of a person included in the image data;
determining, based on the first information, whether a person included in the image data is a non-target, the non-target being a person who is not a target to which a content is presented; and
selecting a content, based on a second information about a person determined not to be a non-target, the first information including the second information.

20. A non-transitory computer-readable storage medium storing instructions to cause a computer to execute operations comprising:
extracting, from image data, a first information about a feature of a person included in the image data;
determining, based on the first information, whether a person included in the image data is a non-target, the non-target being a person who is not a target to which a content is presented; and
selecting a content, based on second information about a person determined not to be a non-target, the first information including the second information.

21. The content selection apparatus according to claim 11, wherein the feature is an image including the person cropped out of the image data.

22. The content selection apparatus according to claim 21, wherein the cropped image includes at least one of an image including a face of a person included in the image data or an image including clothing of the person.

23. The content selection apparatus according to claim 21, wherein the non-target is at least one store employee, a cleaner, or a security guard.
